(19) United States
(12) Patent Application Publication
(10) Pub. No.: US 2008/0015843 A1
(43) Pub. Date: Jan. 17, 2008

(54) Linguistic Image Label Incorporating Decision Relevant Perceptual, Semantic, and Relationships Data

(75) Inventor: Lauren Barghout, Oakland, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Paravue Corporation

(21) Appl. No.: 11/683,864

(22) Filed: Mar. 8, 2007

Related U.S. Application Data
(60) Provisional application No. 60/781,029, filed on Mar. 9, 2006.

(51) Int. Cl. G06F 17/30

(52) U.S. Cl. 704/7; 704/E19.007

(57) ABSTRACT

Data processing system and computer implemented method for obtaining linguistic image labels and populating linguistic image label entries are disclosed. According to one embodiment, a method comprises creating a first data from an image that includes descriptive information of the image. A linguistic image label is populated that includes a first field and a second field wherein the first field contains first data representing a pixel region of a digital image and the second field contains second data representing a visual appearance of the pixel region.

### PRIORITY

The present application claims the benefit of and priority to U.S. Provisional Patent Application No. 60/781,029 entitled “Linguistic Image Label Incorporating Decision Relevant Perceptual, Semantic, and Relationships Data” and filed on Mar. 9, 2006, and is hereby, incorporated by reference.

### CROSS-REFERENCE TO RELATED APPLICATIONS

The present application incorporates by reference U.S. patent application Ser. No. 11/021,013, by Lauren Barghout, entitled “System and Method for Linking linguistic image label Entries to Corresponding Gestalt Image Label Entries”, filed on Dec. 22, 2004, which is a continuation of U.S. patent application Ser. No. 10/618,543, by Lauren Barghout and Lawrence W. Lee, entitled “Perceptual Information Processing System”, which claims the benefit of U.S. Provisional Application No. 60/395,661, filed Jul. 13, 2002, by Lauren Barghout and Lawrence W. Lee, entitled “Perceptual Information Processing System”.

### BACKGROUND OF THE INVENTION

With the advancement of digital photography, video recording technology, and other related digital or non-digital image capturing technologies, the storage, retrieval, management, manipulation, organization, and navigation of the vast amount of image data have become an emerging challenge for the info-imaging industry. In order to efficiently store, retrieve, manage, manipulate, organize, and navigate vast amount of image data, proper image labels are essential. Current image data management primarily relies on a “directory structure” system, in which images are stored on a computer hard drive and arranged in tree-like folder structures. This simple method makes organizing and searching large image collection difficult.

Some of the current formats improve upon the directory system by embedding tags such as time, date, and location, directly within the image data structure. However, these types of tags are still inadequate for digital image management.

In current image labeling technologies, the images are either annotated manually or feature coded from system analysis. Manual annotation of image content is both labor-intensive and inaccurate, with the usefulness of the resulting annotations dependent upon the annotator's verbal interpretations. In the latter case, a system annotates images by comparing feature content to manually selected comparison images or feature templates. The result is often ambiguous and of limited usefulness. Furthermore, the description of an image's content is affected by real world events, requiring the annotation to be updated as relevant world events occur.

### SUMMARY

A data processing system and computer implemented method for obtaining linguistic image labels and populating linguistic image label entries are disclosed. According to one embodiment, a method comprises creating a first data from an image that includes descriptive information of the image. A linguistic image label is populated that includes a first field and a second field wherein the first field contains first data representing a pixel region of a digital image and the second field contains second data representing a visual appearance of the pixel region.

### BRIEF DESCRIPTION OF DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 is an exemplary linguistic image label with linguistic image label entries, according to one embodiment of the present invention.

FIG. 2 is an illustration of a process to populate linguistic image labels according to one embodiment of the present invention.

FIG. 3 is an illustration of a process to populate a linguistic image label utilizing a look-up table, according to one embodiment of the present invention.

FIG. 4 is an illustration of the population of linguistic image label fields with semantic data (and/or descriptive data) according to one embodiment of the present invention.

FIG. 5 is an illustration of linguistic image label fields population, according to one embodiment of the present invention.

FIG. 6 is a block diagram of an exemplary computer architecture for use with the present system, according to one embodiment of the present invention.

### DETAILED DESCRIPTION

A data processing system and computer implemented method for obtaining linguistic image labels and populating linguistic image label entries is disclosed. According to one embodiment, the present invention also includes using a file format that represents semantic and visually descriptive information regarding the content of an image. This information maps comments and textual descriptions to structural elements of the image. The linguistic image label entry constitutes metadata that augments labels associated with image regions, such as a figure region, ground region, and other types of regions or sub-regions. The metadata additionally describes the relationships among regions and objects within the structural decomposition of the image, mimicking human hierarchical object category structure. A technique for manually creating, gathering, or drawing out from an image, semantic data (and/or descriptive data) for populating a linguistic image label entry via a survey method is also described. A technique for automatically creating, gathering, or drawing out from an image, semantic data (and/or descriptive data) for populating a linguistic image label entry via data mining is also described.

In the following description, for purposes of explanation, specific nomenclature is set forth to provide a thorough understanding of the various inventive concepts disclosed herein. However it will be apparent to one skilled in the art that these specific details are not required in order to practice the various inventive concepts disclosed herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk, including floppy disks, optical disks, CD-ROMS, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the inventions as described herein.

According to one embodiment, the following terms may have the following meanings without regard to their upper or lower case usage. However, one of ordinary skill would understand that additional embodiments may contemplate additional terms and/or variations of these terms.

According to one embodiment, a linguistic image label (hereinafter “LIL”) captures semantic phrases describing the visual appearance of an image organized to correspond with nested figure-ground pixel regions. Each of the regions has a corresponding descriptor field. Each descriptor field contains semantic phrases that describe the entire figure or ground region accordingly. According to one embodiment, the terms “figure” and “ground” are used according to the definitions in psychology literature and defined as Gestalt rules of perception. A LIL could also be viewed as a translation of perceptual data to objects and their concepts. Linguistic hedges are words that characterize the degree of applicability of an attribute. A linguistic hedge could also refer to statistical membership values which return an uncertainty value or fitness value. A gestalt image label (hereinafter “GIL”) is any structured description of the variables describing arrangement, pattern, and configurations within an image. In other words, GIL data or entries can be defined as the perceptual analysis of an image based on certain pixel regions. A pixel-region may be defined by a figure-ground hierarchy, or other polygon-regions, or any other method for creating or selecting a certain region of pixels in a digital image.

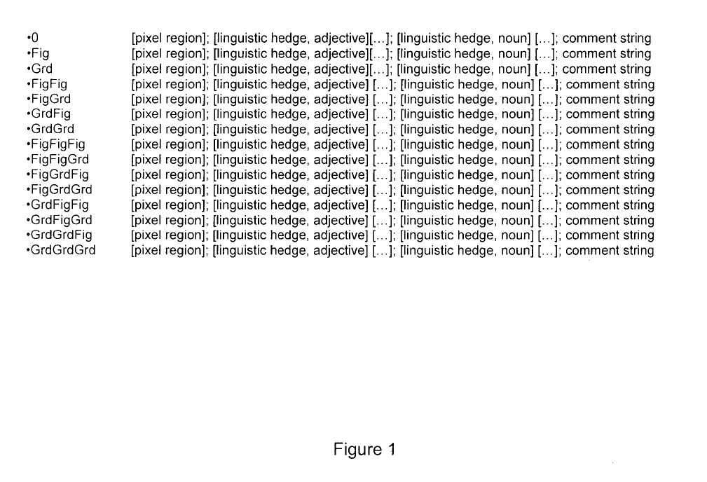

FIG. 1 is an exemplary linguistic image label with linguistic image label entries, according to one embodiment of the present invention. Each LIL entry contains fields for at least a pixel region, and a visual appearance description stored as value pairs. This example includes fields appropriate for adjectives and nouns, where the linguistic hedges may also be represented as statistical membership values. The present invention includes optional additional fields for adjectives and nouns, or adjectives or nouns, or any other number of fields which will assist in the characterization of a pixel region. There may be a very large number of noun entries. One embodiment would select the appropriate number of noun entries based on the data contained in a GIL or an object operatively similar to the GIL. One embodiment of the invention also includes a field for a comment string, as seen in FIG. 1.

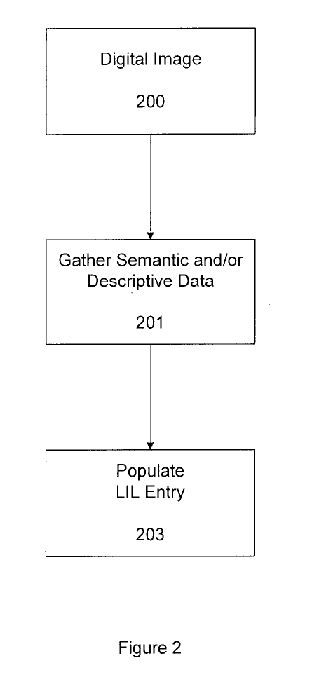

FIG. 2 is an illustration of a process to populate linguistic image label according to one embodiment of the present invention. Semantic and/or descriptive data 201 is created, gathered, or drawn out from image 200. Such semantic and/or descriptive data is used to 203 populate a LIL entry 100. Semantic and/or descriptive data 201 is created, gathered, or drawn out from image 200 in a number of different ways.

Though other ways of creating semantic data, descriptive data, or a combination of both, for storage in a LIL are available, to enable one skilled in the art, the system and method is described using the following examples for creating, gathering, or drawing out from an image, semantic data, descriptive data, or a combination of both: Look-up Tables; Manual Survey methods; and Data Mining tags or labels from multimedia or hypertext.

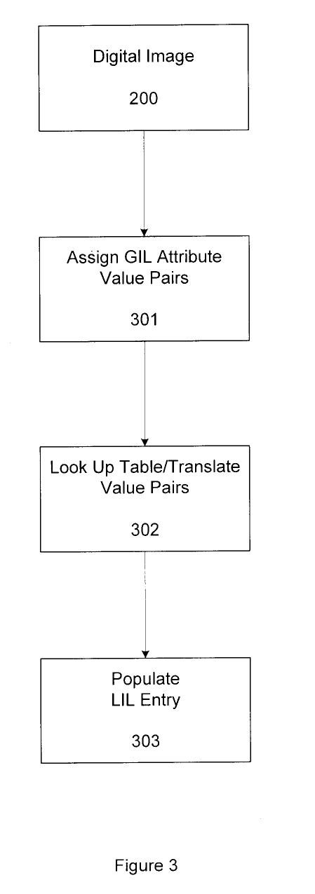

FIG. 3 is an illustration of a process to populate linguistic image label utilizing a Look-up Table according to one embodiment of the present invention. The creation of, gathering of, or drawing out from an image, semantic data (and/or descriptive data) 201 of FIG. 2 is done by the assignment of attribute value pairs 301. In this embodiment, the data is stored in a GIL. The assignment of attribute value pairs is not restricted to storage in a GIL. Any data that is operatively similar to a GIL or an object holding data that is operatively similar to a GIL, would suffice for the present invention. For example, a data structure or other storage device containing data that is operatively similar to a GIL also suffices. In one embodiment of the invention, the GIL, or data operatively similar to it, has been created or defined in advance.

Once assignment of GIL attribute value pairs 301 has completed with the data stored into a GIL the data is processed to obtain semantic data, descriptive data, or a combination of both, which is stored into a LIL. This may be done with the use of Look-up Tables 302, or a translation of the value pairs.

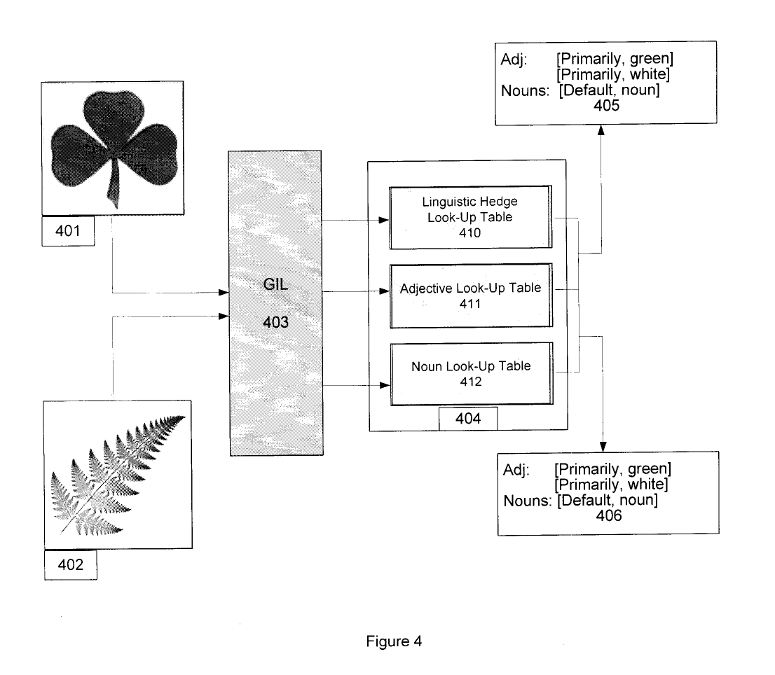

FIG. 4 is an illustration of the population of linguistic image label fields with semantic data (and/or descriptive data), according to one embodiment of the present invention. FIG. 4 illustrates the processing of two different images 401 and 402, resulting in two different LIL data entries 405 and 406 based on the two different images 401 and 402, respectively. The images 401 and 402 are processed at level 0 of the figure-ground hierarchy. For clarity, level 0 (zero) refers to the level of an image where the entire image is utilized for LIL entry population. In other words, level 0 refers to the image as a whole (i.e. before any true discerning of figure or ground). The images in FIG. 4 are at their basic level of processing. Images 401 and 402 are utilized with the inclusion of the plant-like subject matter and the white space surrounding that subject matter.

The images 401 and 402 are assigned GIL attribute values by GIL processor 403. The GIL attribute values are translated into semantic data (and/or descriptive data). The GIL attribute values could be converted into many different translations, including English or foreign language vernaculars, or industry specific vernaculars such as medical terminology, or any other vernacular. The Look-up Table 404 is based on terminology of a specialized profession in fields such as botany, computer science, medicine, architecture, or any other field for which the present invention is utilized. The intended audience may determine a particular translation used. The GIL attribute values are utilized to determine the contents of an image or the object concepts within the image. One technique for determining the contents of an image compares the data stored in the GIL attribute values to other databases of image exemplars, or prototypes, or a combination of both, and searches for similar or matching visual data that shares the same characteristic attributes. Such databases exist in Look-up Tables 404.

Thus, the GIL attribute values 403 are set manually or automatically to level 0 in this embodiment Images 401 and/or 402 are compared or translated within look-up table 404 to produce semantic data (and/or descriptive data) for its LIL entry.

Data record 405 that is created, gathered or extracted out from image 401 includes: Adjective: [Primarily, green], [Primarily, white]; Nouns: [Default, noun]. Data record 405 is an example of what is created, gathered, or drawn out from an image. Data record 405 is then utilized to populate a LIL entry for image 401. The linguistic hedge look-up table 410 outputs semantic data (and/or descriptive data) in human linguistic terms or phrases that represent characterizations of quantities or certainties. The contents of linguistic hedge look-up table 410 includes, but is not limited to, words or phrases such as: “a lot”, “very”, “almost”, or “somewhat”. If the GIL input stated 90% of a certain characteristic, attribute, or quality, the linguistic hedge look-up table 410 produces a result of “very” while 30% might produce a result of “somewhat”, respectively. The exemplary embodiment described for the linguistic hedge look-up table 410 may be tailored to represent the more complex nuances of human visual perception. The process of creation, gathering, or drawing out from an image, semantic data (and/or descriptive data) attaches, joins, or affiliates appropriate linguistic hedges to each adjective and noun value depending on the prominence of that value at the relevant level of the image. Further, the prominence of that value, described above as the quantities and certainties of that value, are used to broaden or tighten the set membership of the LIL entry. For example, a LIL entry that states, “Edge loosely resembles a fern-like edge,” would extend the membership of the edge set “fern-like.” But, a LIL entry that states, “Strictly resembles a fern-like edge,” would tighten the set membership to include only the image objects that have a very high probability of being “fern-like.”

In FIG. 4, semantic data for LIL entry from image 401 as shown in data record 405 resulted from linguistic hedge look-up table 410 by providing the semantic data the term “primarily”. The adjective look-up table 411 provides adjectives that are based on the level of the figure-ground hierarchy that the image GIL attribute values were set. For example, the adjectives are more descriptive depending on the level of the figure-ground hierarchy to which the GIL attribute values are set. These adjectives can be of any language, vernacular, or jargon, because look-up table 404 is language, vernacular, or jargon based. The adjective look-up table 411 returns terms such as “green” and “white.”

The noun look-up table 412 provides nouns that are associated with the level of the figure-ground hierarchy to which the image GIL attribute values are set. For example, the nouns may be more descriptive depending on the level of the figure-ground hierarchy to which the GIL attribute values are set. For this example, since the image is at level 0, the entire image was seen as a whole and the linguistic hedge look-up table 410 produces an output of “Default” in data record 405 in reference to the characterizations of quantities or certainties for nouns. “Default” in this example serves as an output when a reliable categorization for the noun field is not found. Further, since the linguistic hedge look-up table 410 was unable to find a reliable categorization for the noun, the noun look-up table 412 returns a default value. In FIG. 4, the default output in data record 405 is “noun.” The “Default” action taken when a reliable category/semanticdata/descriptive data is not found is an example of the additional capability of the present invention. Thus, the image 401 may actually produce a reliable linguistic hedge and noun based on the Look-Up Table 404 and GIL attribute value setting.

FIG. 4 also illustrates of another sample image 402 which when processed resulted in LIL data record 406. LIL entry data 406 was created from the creation, gathering of, or extracting, semantic data (and/or descriptive data) from image 402 in a process that is similar to the one described above for data record 405 associated with image 401. One should note that though images 401 and 402 are quite different, the same output of semantic data (and/or descriptive data) was developed for each of them. Though these may not be the exact outputs, the semantic data (and/or descriptive data) in FIG. 4 for each are the same to illustrate that these images will likely produced very similar results at level 0. It should be evident to one skilled in the art that the results may vary in that fewer or additional linguistic hedges and/or adjectives and/or nouns may also result.

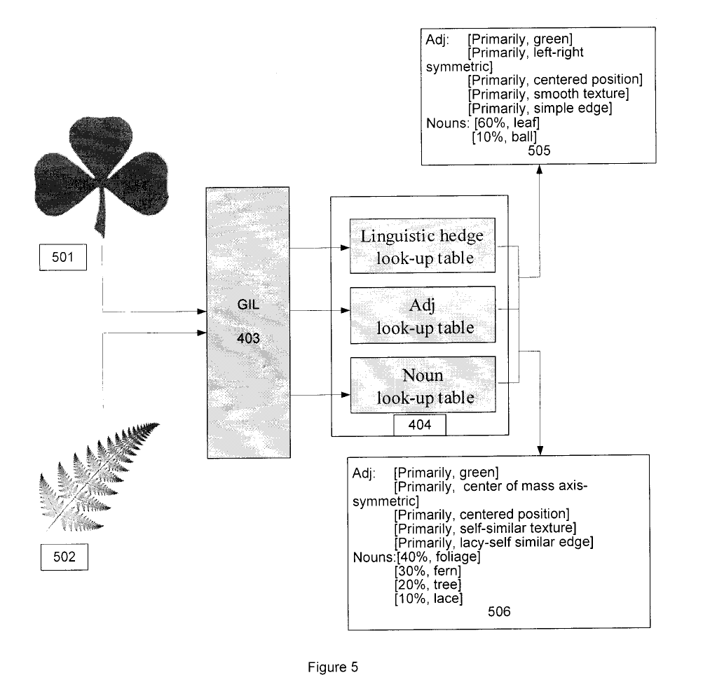

FIG. 5 is an illustration of linguistic image label field population with semantic data (and/or descriptive data) by utilizing the gestalt image label attribute values of an image at level “Figure”. For clarification, level “Figure” is one level lower than level 0 as described above. “Figure” denotes its ordinary meaning according to gestalt rules of perception as defined in psychology literature. In other words, the GIL attribute values are based on a lower, subordinate level of the figure-ground hierarchy of an image. It should be evident to one skilled in the art that the image may be at any level of a figure-ground hierarchy and here, the level “Figure” may also mean any level below level 0. This level is referred to as level “figure” for example. As illustrated in FIG. 5, the figure level selected in this embodiment is the shamrock 501 and the fern leaf branch 502, referred to as the plant-like subject matter above. Since the pixel region being referred to (the figure) is now defined as one level lower than the entire image, the processing is based only on that subject matter and not the white space, since, in this example, the white space is not contained within the level one figure region.

FIG. 5 illustrates similar processing as FIG. 4. The example in FIG. 5 assumes more iterations of data processing than FIG. 4 based on more GIL attribute values at level “figure”. The depth of the LIL data corresponds to the depth of the GIL attribute values, and the level for GIL attribute values correspond to that lower level (level figure) of the inputted image. The created, gathered, or extracted semantic data (and/or descriptive data) for images 501 and 502 are reflected in data record 505 and 506, respectively. With the input of more GIL attribute values, level one data records 505 and 506 are larger and more defined then their respective level-zero data records counterparts 405 and 406. It should be evident to those skilled in the art that though this is true of the images 401 and 402 as compared to 501 and 502, more GIL attribute values are not necessarily produced as an image is evaluated at lower hierarchy levels.

Optionally, semantic data (and/or descriptive data) could be created, gathered, or extracted from an image 201 (FIG. 2) for LIL population by the use of manual survey process. Manual survey process involves the creating, gathering, or extracting data from an image by conducting a survey in which humans label the image and/or parts of the images with a label or phrase and location marker from which a figure-ground hierarchy may be inferred. The survey may also include direct measure of perceptual attributes of certain images, such as color, symmetry, or other characteristics. It should be evident to one skilled in the art that the manual survey method may be carried out in numerous ways so long as semantic data (and/or descriptive data) can be created, gathered, or extracted from an image or portions of an image.

Optionally, semantic data (and/or descriptive data) could be created, gathered or extracted from image 201 (FIG. 2) for LIL population by the use of data mining. Generally, tags can be attached to an image or to certain regions of an image (hereinafter “bounding box”). A tag may be defined as metadata associated with an image or a bounding box and could be any unstructured word. Tags are extracted from any number of sources, including HTML pages on the web (especially at social book-marking websites). The tags attached to an image or bounding box are utilized by the present invention to further populate a LIL with entries.

In the process for creating, gathering, or extracting semantic data (and/or descriptive data) from an image for LIL population using tags through data mining, the system processes the entire image for a hierarchy of figure-ground through a GIL creation process as explained in U.S. patent application Ser. No. 11/021,013 entitled “System and Method for Linking Linguistic Image Label Entries to Corresponding Gestalt Image Label Entries” or, optionally, through a manual survey technique as explained above or any other technique allowing the creation of data operatively similar to GIL data such that it may be used to create, gather, or extract from an image, semantic data (and/or descriptive data) which is used to populate a LIL.

The image is processed to determine to which level of the hierarchy the tags or data, which have been linked to the image or bounding box, relate or correspond. To do so, a center of mass is calculated from the GIL figure region and the corresponding bounding box. This allows for choosing the optimal figure ordinate level for the tag. The information in the tag is used to add entries to the LIL at the appropriate hierarchical location. Optionally, the located hierarchy is also located in the corresponding LIL entry (once a LIL process has been completed) before the data is added, thereby allowing an existing LIL entry to further include the tag data in addition to existing data.

The data from the tag, depending on its source, is used to provide an entire new field that is defined by the input from the tag. For example, a new field for “Proper Noun” is added to a tag which holds a person's name based on a bounding box surrounding that person's face. Thus, the “Proper Noun” entry added is the person's name. Also, depending on the source of the tag, the linguistic hedge for the new field is defined with a more definite description, such as “100%” or “Completely” or “Absolute” or any other description that shows a high degree of certainty. This is determined based on the source of the tag or the source of the image or the source of the bounding box. If the respective sources do not provide reliable data, then the more definite description is not be used, and more appropriate descriptions are used. Optionally, the system determines whether the tags used on an image or bounding box are appropriate, or correct, and determines whether the tags may be used.

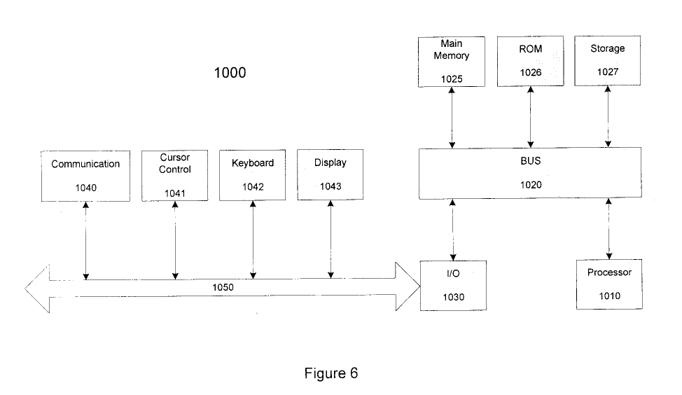

FIG. 6 is an illustration of an exemplary computer architecture for use with the present system, according to one embodiment. Computer architecture 1000 is used to implement the computer systems or image processing systems described in various embodiments of the invention. One embodiment of architecture 1000 comprises a system bus 1020 for communicating information, and a processor 1010 coupled to bus 1020 for processing information. Architecture 1000 further comprises a random access memory (RAM) or other dynamic storage device 1025 (referred to herein as main memory), coupled to bus 1020 for storing information and instructions to be executed by processor 1010. Main memory 1025 is used to store temporary variables or other intermediate information during execution of instructions by processor 1010. Architecture 1000 includes a read only memory (ROM) and/or other static storage device 1026 coupled to bus 1020 for storing static information and instructions used by processor 1010.

A data storage device 1027 such as a magnetic disk or optical disk and its corresponding drive is coupled to computer system 1000 for storing information and instructions. Architecture 1000 is coupled to a second I/O bus 1050 via an 1/O interface 1030. A plurality of I/O devices may be coupled to I/O bus 1050, including a display device 1043, an input device (e.g., an alphanumeric input device 1042 and/or a cursor control device 1041).

The communication device 1040 is for accessing other computers (servers or clients) via a network. The communication device 1040 may comprise a modem, a network interface card, a wireless network interface, or other well known interface device, such as those used for coupling to Ethernet, token ring, or other types of networks.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this detailed description, but rather by the claims following.

I claim:

1. A computer readable medium, comprising:
a first field containing first data associated with a pixel region of a digital image; and
a second field containing second data associated with a visual appearance of the pixel region.

2. The computer readable medium of claim 1, wherein the second data comprises:
a linguistic hedge; and
a modifier, wherein the linguistic hedge is associated with the modifier.

3. A data processing system, comprising:
a processor; and
a memory device connected to the processor, wherein the memory device stores a linguistic image label processed by the processor, and wherein the linguistic image label includes a first field and a second field, wherein the first field contains first data associated with a pixel region of a digital image and the second field contains second data associated with a visual appearance of the pixel region.

4. The data processing system of claim 3, wherein the second data comprises:
a linguistic hedge; and
a modifier, wherein the linguistic hedge is associated with the modifier.

5. A method, comprising:
creating a first data from an image that includes descriptive information of the image; and
populating a linguistic image label that includes a first field and a second field wherein the first field contains first data associated with a pixel region of a digital image and the second field contains second data associated with a visual appearance of the pixel region.

6. The method of claim 5, wherein a computer creates a first data from an image and populates the linguistic image label.

7. The method of claim 5, wherein a manual survey is utilized for creating the first data from the image.

8. The method of claim 5, wherein creating the first data from the image is accomplished by data mining.

9. The method of claim 6, wherein the computer utilizes a look-up table, the look-up tabling providing a translation of a semantic data into a second data, the second data being used to populate the linguistic image label.

10. The method of claim 9, wherein the look-up table comprises a first information look-up table and a second information look-up table, wherein the first information look-up table is used to create a linguistic hedge and the second information look-up table is used to create a modifier, the linguistic hedge being associated with the modifier.

11. The method of claim 5, wherein the second data comprises:
a linguistic hedge; and
a modifier, wherein the linguistic hedge is associated with the modifier.

12. A computer readable medium having stored thereon a plurality of instructions, the plurality of instructions when executed by a computer, cause the computer to perform:
creating a first data from an image that includes descriptive information of the image; and
populating a linguistic image label that includes a first field and a second field wherein the first field contains first data associated with a pixel region of a digital image and the second field contains second data associated with a visual appearance of the pixel region.

13. The computer readable medium of claim 12, wherein a manual survey is utilized for creating the first data from the image.

14. The computer readable medium of claim 12, wherein creating the first data from the image is accomplished by data mining.

15. The computer readable medium of claim 12, wherein the computer utilizes a look-up table, the look-up tabling providing a translation of a semantic data into a third data, the third data utilized to populate the linguistic image label.

16. The computer readable medium of claim 15, wherein the look-up table comprises a first information look-up table and a second information look-up table, wherein the first information look-up table is utilized for creating a linguistic hedge and the second information look-up table is utilized for creating a modifier, the linguistic hedge being associated with the modifier.

17. The computer readable medium of claim 12, wherein the second data comprises:
a linguistic hedge; and
a modifier, wherein the linguistic hedge is associated with the modifier.

18. A computer system, comprising:
a processor; and
memory coupled to the processor, the memory storing instructions;
wherein the instructions when executed by the processor cause the processor to:
create a first data from an image that includes descriptive information of the image; and
populate a linguistic image label that includes a first field and a second field wherein the first field contains first data associated with a pixel region of a digital image and the second field contains second data associated with a visual appearance of the pixel region.

19. The computer system of claim 18, wherein a manual survey is used to create the first data from the image.

20. The computer system of claim 18, wherein the processor further creates the first data from the image by data mining.

21. The computer system of claim 18, wherein the computer uses a look-up table, the look-up tabling providing a translation of a semantic data into a second data, the second data able to populate the linguistic image label.

22. The computer system of claim 21, wherein the look-up table comprises a first information look-up table and a second information look-up table, wherein the first information look-up table is used to create a linguistic hedge and the second information look-up table is used to create a modifier, the linguistic hedge being associated with the modifier.

23. The computer system of claim 18, wherein the second data comprises:
a linguistic hedge; and
a modifier, wherein the linguistic hedge is associated with the modifier.
